(19) United States
(12) Patent Application Publication
(10) Pub. No.: US 2004/0158513 A1
(43) Pub. Date: Aug. 12, 2004

(54) Employment salary information system and method

(76) Inventor: Joseph Musacchio, Merrick, NY (US)

Correspondence Address: NIXON PEABODY, LLP, 401 9TH STREET, NW, SUITE 900, WASINGTON, DC, 20004-2128, US

(21) Appl. No.: 10/606,936

(22) Filed: Jun. 27, 2003

Related U.S. Application Data
(60) Provisional application No. 60/391,926, filed on Jun. 28, 2002.

(51) Int. Cl. G06F 17/60

(52) U.S. Cl. 705/32

(57) ABSTRACT

A system and method for providing employment salary information. The system includes an employment salary database having salary data with skill information, a user interface module to input employment parameter information including specific skills, and a processor to generate a skill matched data set by searching the employment salary database to identify salary data having the inputted specific skill associated thereto, and generate salary information based on salary data of the skill matched data set. The method includes the steps of providing an employment salary database having salary data with skill information, inputting employment parameter information including a specific skill, providing a skill matched data set by searching the employment salary database to identify salary data with the inputted skill, and generating salary information based on salary data of the skill matched data set. A data storage media having data instructions for providing employment salary information.

This application claims priority to U.S. Provisional Application No. 60/391,926, filed Jun. 28, 2002.

### BACKGROUND OF THE INVENTION

1. Field of the Invention

The present invention is directed to a system and method for providing employment information. In particular, the present invention is directed to a system and method for providing employment salary information.

2. Description of Related Art

Many individuals find employment as employees or consultants, via fairly conventional techniques involving word-of-mouth, newspaper advertisement, job fairs, personal contacts and/or employment agencies or vendors. In many instances, a highly trained individual seeks employment via a placement agency or personnel vendor. Such agencies often charge fees that reduce the amount of compensation that can be paid to the employee or consultant.

For example, corporations often acquire Information Technology (IT) consultants from placement agencies or vendors that specialize in staffing of IT professionals. Placement agencies assist the corporation's hiring manager in locating a qualified candidate and present the candidate's resume. The hiring manager then may choose to interview and hire the candidate. Many corporations hire employees that have been referred from an “approved vendor list”, thus limiting access to opportunities that would otherwise be more widely available.

U.S. Patent No. 5,862,223 to Walker et al. discloses an Internet based method and apparatus for facilitating the matching of experts having particular qualifications and end users seeking solutions to expert requests. This system contemplates pre-screening and certification of experts to attest to the qualifications of the expert. Pricing of the services is achieved via one of a variety of different auction models. When the job is complete, payment may be made through a payment mechanism implemented by the system, and such payment may be contingent on the satisfaction of the end user.

For employers, employees, and placement agencies/vendors alike, accurate salary information is desirable to ensure that the employee is being compensated fairly. In particular, employers want to be sure that the hired employee is not being overpaid in comparison to other comparable employees in the market place. On the other hand, the employees want to be sure that they are not being underpaid in comparison to other comparable employees in the market place. Moreover, the placement agencies/vendors also want to be sure that the employees are not being underpaid since the placement agencies/vendors typically receive a percentage of the salary to the employee that is hired through the placement agency/vendor.

Presently, employment salary information is made available by various sources on the Internet. Employment salary information provided such sources is generally obtained through on-line surveys of employees. In particular, these surveys require the employee to select the industry of employment, the job title from a listing (or a drop down menu) of job titles, and the corresponding annual salary. The employment salary information for each of the job titles are then analyzed to provide statistical salary information. For example, the average salary for each of the job titles may be calculated and displayed together with a 25^{th} percentile and 75^{th} percentile salaries for each of the job titles.

The above described employment salary information that is generated using survey information is not very accurate in that it fails to take into consideration, various employment parameters that significantly impact employee salaries. For instance, the salary information can quickly become outdated as the job market conditions change or fluctuate. In addition, the present inventors have recognized that in the real workplace, job titles and job function may actually deviate significantly. Thus, while employees of two different organizations may hold the same job titles, they may actually perform very different functions in their respective organizations, and correspondingly, have very different functional skills.

Furthermore, the present inventors have also recognized that various other employment parameters that significantly impact employment salaries, are not taken into consideration when providing such survey information. In particular, such survey information does not take into consideration variation in salaries based on the local geographical market. In addition, such survey information does not take into consideration the experience levels of the employees providing the salary information. Moreover, such survey information does not take into consideration actual functional skill set of the employee.

Therefore, there remains an unfulfilled need for a system and method for providing employment salary information with enhanced accuracy. In addition, there exists an unfulfilled need for such a system and method that provides updated employment salary information which takes into consideration, the geographical location of employment, experience and the level of expertise, as well as the actual functional skill set of the employee.

### SUMMARY OF THE INVENTION

In view of the foregoing, an advantage of the present invention is in providing a system and method for providing updated salary information with enhanced accuracy.

Another advantage of the present invention is in providing a system and method that provides employment salary information which takes into consideration the geographical location of employment.

Yet another advantage of the present invention is in providing a system and method that provides employment salary information which takes into consideration the level of expertise.

Still another advantage of the present invention is in providing a system and method that provides employment salary information which takes into consideration actual functional skill set and experience.

Another advantage of the present invention is in providing a system and method that provides employment salary information derived from actual salary data.

These advantages and others are obtained by a system for providing employment salary information in accordance with one aspect of the present invention, the system comprising an employment salary database having salary data with associated skill information, a user interface module adapted to allow input of employment parameter information including at least one specific skill, and a processor adapted to generate a skill matched data set by searching the employment salary database to identify salary data having the inputted specific skill associated thereto, and generate salary information based on salary data of the skill matched data set.

In accordance with one embodiment of the present invention, the inputted employment parameter information may also include skill level, and the processor may further be adapted to establish plurality of skill level categories. The processor may establish the plurality of skill level categories by dividing at least a portion of the salary data in the employment salary database into predetermined percentile salary ranges, and correlate each of the predetermined percentile salary ranges to the plurality of skill level categories. In this regard, the processor may further be adapted to generate the salary information based also on the inputted skill level, and salary data of one of the predetermined percentile salary ranges.

In accordance with another embodiment, the salary data may include associated job titles, and the inputted employment parameter information may further include a job title. In this regard, the processor may be further adapted to narrow the salary data by searching the employment salary database to identify salary data having the inputted job title associated thereto. In addition, the processor may be further adapted to generate the salary information based also on the inputted job title.

In accordance with still another embodiment, the salary data may include associated location data, and the inputted employment parameter information may further include location information. In this regard, the processor may be further adapted to narrow the salary data by searching the employment salary database to identify salary data having the inputted location data associated thereto. In addition, the processor may be adapted to generate salary information based on the inputted location information.

In accordance with yet another embodiment, system of the present invention may further comprise a data miner adapted to periodically mine employment salary data. The processor may be further adapted to store the mined employment salary data in the employment salary database. In this regard, the data miner may be adapted to periodically mine employment data through a distributed network. Moreover, the data miner may be adapted to mine salary data from job listings and/or employment histories.

In accordance with still another embodiment of the present invention, the generated employment salary information includes average annual salary that is periodically updated. In this regard, the system of the present invention may further comprise a ticker adapted to render the generated employment salary information. In one implementation, the ticker renders direct labor hourly rate, highs and lows of the direct labor hourly rate, and/or amount of change in the direct labor hourly rate. In another implementation, the ticker renders an hourly pay rate that includes fees charged by an employment agency, and/or amount of fees charged by an employment agency as a percentage of an hourly pay rate.

In accordance with another aspect of the present invention, a system for providing employment salary information is provided, the system comprising an employment salary database having salary data, a user interface module adapted to allow input of employment parameter information including at least one specific skill, and a processor adapted to establish a plurality of skill level categories by dividing at least a portion of the salary data in the employment salary database into predetermined percentile salary ranges, and generate salary information based on the inputted skill level and salary data of one of the predetermined percentile salary ranges. In accordance with one embodiment, the processor is further adapted to correlate each of the predetermined percentile salary ranges to the plurality of skill level categories.

In addition, the above noted advantages and others are obtained by a method for providing employment salary information in accordance with another aspect of the present invention, the method comprising the steps of providing an employment salary database having salary data with associated skill information, inputting employment parameter information, wherein the employment parameter information includes at least one specific skill, providing a skill matched data set by searching the employment salary database to identify salary data with the inputted skill associated thereto, and generating salary information based on salary data of the skill matched data set.

In accordance with one embodiment, the present method may further include the step of establishing plurality of skill level categories which may include the step of dividing at least a portion of the salary data in the employment salary database into predetermined percentile salary ranges. In addition, the method may further include the step of correlating each of the predetermined percentile salary ranges to the plurality of skill level categories. The salary information generated may be further based on salary data of one of the predetermined percentile salary ranges. The inputted employment parameter information may also include a skill level so that the salary information generated is further based on the inputted skill level.

In accordance with another embodiment of the present method, the salary data may include associated job titles, and the inputted employment parameter information may further include a job title. In this regard, the salary information generated may be further based on the inputted job title. In addition, the method may further include the step of narrowing the salary data by searching the employment salary database to identify salary data having the inputted job title associated thereto. Furthermore, the salary information generated may be further based on the inputted job title.

In accordance with still another embodiment of the present method, the salary data includes associated location data, and the inputted employment parameter information further includes location information. In this regard, the salary information generated may be further based on the inputted location information. The method may also include the step of narrowing the salary data by searching the employment salary database to identify salary data having the inputted location data associated thereto. Thus, the salary information generated may further be based on the inputted location data.

In accordance with still another embodiment of the present invention, the method may further include the step of periodically mining employment salary data, and the step of storing the mined employment salary data in the employment salary database. The employment salary data may be mined through a distributed network and may be from job listings and/or employment histories of employees.

In accordance with one embodiment, the generated employment salary information includes average annual salary. In another embodiment, the method may further include the step of periodically updating the generated employment salary information. In this regard, the generated employment salary information may be rendered as a ticker. In one implementation, the ticker may include direct labor hourly rate, highs and lows of the direct labor hourly rate, and/or amount of change in the direct labor hourly rate. In another implementation, the ticker may include an hourly pay rate that includes fees charged by an employment agency, and/or amount of fees charged by an employment agency as a percentage of an hourly pay rate.

In accordance with another aspect of the present invention, a method for providing employment salary information is provided, the method comprising the steps of providing an employment salary database having salary data, establishing plurality of skill level categories by dividing at least a portion of the salary data in the employment salary database, inputting employment parameter information, wherein the employment parameter information includes skill level information, and generating salary information based on salary data of one of the established skill level categories.

In accordance with one embodiment, the step of establishing plurality of skill level categories by dividing at least a portion of the salary data may include dividing the portion of the salary data into predetermined percentile salary ranges. In this regard, the salary information generated may be further based on the inputted skill level.

In accordance with still another aspect of the present invention, a data storage media with computer executable instructions for providing employment salary information is provided. In accordance with one embodiment, the data storage media comprises instructions for providing an employment salary database for storage of salary data with associated skill information, instructions for allowing input of employment parameter information, wherein the employment parameter information includes at least one specific skill, instructions for providing a skill matched data set by searching the employment salary database to identify salary data with the inputted skill associated thereto, and instructions for generating salary information based on salary data of the skill matched data set. In this regard the data storage media may also further include instructions for establishing plurality of skill level categories.

In accordance with yet another aspect of the invention, a data storage media with computer executable instructions for providing employment salary information is provided. In accordance with one embodiment, the data storage media includes instructions for providing an employment salary database having salary data, instructions for establishing plurality of skill level categories by dividing at least a portion of the salary data in the employment salary database, instructions to allow input of employment parameter information, wherein the employment parameter information includes skill level information, and instructions for generating salary information based on salary data of one of the established skill level categories.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of a system for providing employment salary information output in accordance with one embodiment of the present invention.

FIG. 2 illustrates an example input screen of a user interface for the system of FIG. 1 which may be used to specify employment parameter information.

FIG. 3 is an example output screen in accordance with one implementation of the present invention.

FIG. 4 shows the output screen of FIG. 3 in which comparative employment salary information output is displayed.

FIG. 5 is an example implementation of a ticker which may be used to display the generated salary information output.

FIG. 6 is an example implementation of an options screen in accordance with one embodiment of the present invention.

FIG. 7 shows the options screen of FIG. 6 with an alert being edited.

FIG. 8 shows an industry summary screen in accordance with one example implementation of the present invention.

FIG. 9 shows a flow diagram of a method for providing employment salary information output in accordance with one embodiment of the present invention.

FIG. 10 shows a flow diagram of a method for providing employment salary information output in accordance with another embodiment of the present invention.

### DETAILED DESCRIPTION OF THE PREFERRED EMBODIMENT

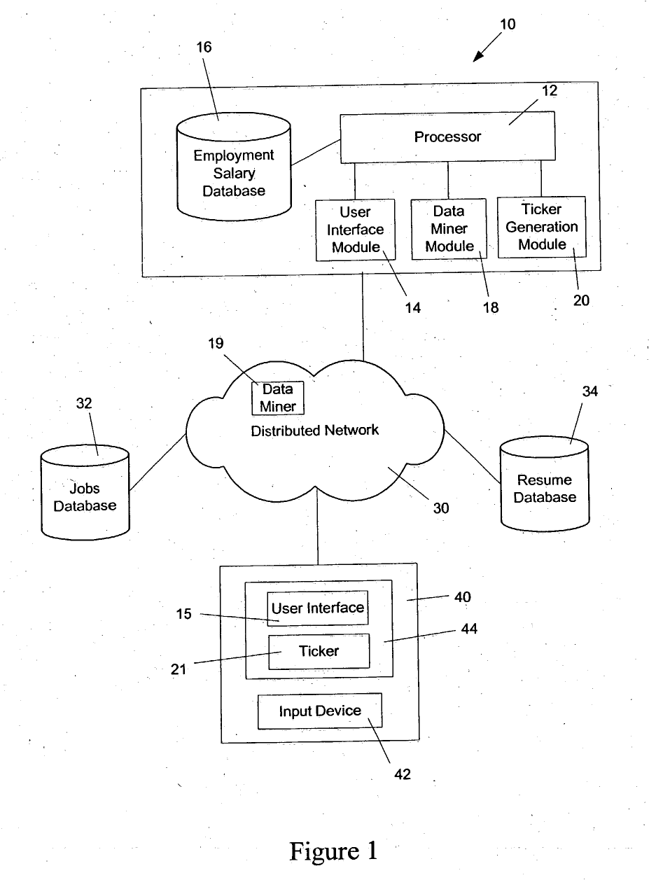

FIG. 1 shows a schematic illustration of an employment salary information system 10 in accordance with one embodiment of the present invention. As will be evident from the discussion herein below, the employment salary information system 10 is adapted to provide updated employment salary information output with enhanced accuracy as compared to similar systems of the prior art. Furthermore, it will also be evident that the employment salary information system 10 provides the employment salary information output by taking into consideration, the geographical location of employment, and experience the level of experience/expertise, as well as the actual functional skill set of the employee.

In the above regard, it should initially be understood that the term “employment” as used herein broadly refers to all types of employment including contract employment, consulting employment, contingent employment, temporary employment and the like, as well as permanent employment, such as full-time, part-time, salaried, etc. Consequently, various terms used in conjunction with the term “employment” should be understood to be correspondingly broad in scope. For instance, the term “employment salary information” refers to salary information associated with the various different types of employment such as contract employment, consulting employment, contingent employment, temporary employment and the like, as well as permanent employment.

In accordance with the illustrated embodiment of the present invention, the employment salary information system 10 is provided with a processor 12 which is adapted to control and/or facilitate functions of the employment salary information system 10 as described in detail below. It should be initially noted that the employment salary information system 10 of FIG. 1 may be implemented with any type of appropriate hardware and software, and may be a general purpose computing device with the central processing unit (CPU) serving as the processor 12. Of course, it should be evident that the employment salary information system 10 may be implemented using a server, a personal computer, a portable computer, a thin client, etc. or any combination of such devices. In this regard, the employment salary information system 10 may be a single device at a single location as shown, or multiple devices at a single, or multiple, locations that are connected together using any appropriate communication protocols over any communication medium such as electric cable, fiber optic cable, any other cable, or in a wireless manner using radio frequency, infrared, or other technologies.

It should also be noted that the employment salary information system 10 in accordance with the embodiment of the present invention is illustrated and discussed herein as having various modules which perform particular functions. It should be understood that these modules are merely schematically illustrated based on their function for clarity purposes only, and do not necessary represent specific hardware or software. In this regard, these modules and/or sub-modules may be hardware and/or software implemented to substantially perform the particular functions explained. Thus, the present invention as schematically embodied in FIG. 1 should not be construed to limit the employment salary information system 10 of the present invention, but be understood to merely be a schematic example.

Referring again to FIG. 1, the employment salary information system 10 also includes a user interface module 14, an employment salary database 16, a data miner module 18, and a ticker generation module 20, all of which are connected to the processor 12. The processor 12 is adapted to control these components of the employment salary information system 10 to provide the functions and features as discussed herein below.

The employment salary information system 10 of the illustrated embodiment is connected to a distributed network 30 which allows remote access to the employment salary information system 10 by remote users via access device 40. The access device may be any appropriate device for accessing the employment salary information system 10 such as a general purpose computing device or other devices noted above.

The access device 40 of the illustrated embodiment includes an input device 42 and an output device 44, these devices allowing the user of the access device 40 to obtain employment salary information output from the employment salary information system 10 via the distributed network 30. In this regard, the input device 42 may include a keyboard, mouse, etc. as well as data input devices such as memory devices based on magnetic, optical and/or solid state technologies including disk drives, CD/DVD drives, flash memory, etc. The output device 44 may include a monitor screen, printer, etc. that allow the user of the access device 40 to obtain the employment salary information output from the employment salary information system 10.

As shown, the distributed network 30 may also be connected to various databases for providing employment salary data/information. For example, the distributed network 30 may be connected to a jobs database 32 which has employment salary data from job listing or the like. In addition, the distributed network 30 may also be connected to a resume database 34 which provides employment salary data/information obtained from employment histories of employees. The distributed network 30 may be any type of communications channel such a local area network (LAN), a wide area network (WAN), direct computer connections, and/or wireless connections using radio frequency, infrared, or other wireless technologies using any appropriate communication hardware and protocols, and may further be the Internet. In addition, the jobs database 32 and the resume database 34 may be publicly accessible databases and/or proprietary databases or other sources of salary information which may be used in the manner further described below. The specific details of the above referenced devices and technologies are well known in the art, and thus, are omitted herein.

Referring again to FIG. 1, the employment salary database 16 of the employment salary information system 10 stores salary data with associated functional skill information. The employment salary database 16 may be structured and operated in any appropriate manner to store salary data with any information associated therewith, such as the functional skill information noted, so that the stored salary data may be retrieved based on the information associated thereto.

In accordance with the illustrated embodiment, the user interface module 14 of the employment salary information system 10 is adapted to generate user interface 15 in the output device 44 of the access device 40. The user of the access device 40 can input employment parameter information including one or more specific functional skills into the user interface 15 via the input device 42. The user interface 15 provides the inputted information to the employment salary information system 10 via the distributed network 30. Of course, functional skills are merely one example of the input employment parameter, and various other parameters that effect employment salaries may be provided as well, some of which are described in further detail below. For example, additional other input employment parameters may include, geography location, skill level, job title, etc.

Referring to the above example where the input employment parameter is a functional skill, the processor 12 is adapted to generate a skill matched data set by searching the employment salary database 16 to identify the salary data having the inputted functional skills associated thereto, which as described above, is inputted by the user of the access device 40. The employment salary information system 10 is adapted to generate salary information output based on the salary data of the generated skill matched dataset. The salary information output may include direct labor hourly rate which is the rate paid to the employee, highs and lows of the direct labor hourly rate, and/or amount of change in the direct labor hourly rate. In industries where vendors and placement agencies are commonly used, the salary information output that is generated by the employment salary information system 10 may also include hourly pay rate (bill rate) that includes fees charged by an employment agency, and/or amount of fees charged by an employment agency as a percentage of an hourly pay rate. The generated salary information is provided to the access device 40 so that it may displayed in the user interface 15 and/or rendered as a ticker 21 which is generated by the ticker generation module 20.

By obtaining the salary data stored in the employment salary database 16 which is directly associated with the inputted functional skill, and generating salary information output based on the skill matched dataset, the employment salary information system 10 provides salary information output which is more accurate than conventional salary information systems. In particular, in contrast to the conventional salary information systems, the employment salary information system 10 of the present invention does not use salary data in the employment salary database 16 which does not relate or is not associated with the particular inputted functional skill.

In addition, in contrast with some conventional salary information systems that generate salary information output based on a selected, predefined job title, the employment salary information system 10 utilizes the actual functional skill to generate salary information output with enhanced accuracy. This is an important distinction in that as previously noted, many organizations utilize the same job titles for employee positions, but the employees may actually perform different functions within the organization, and may have significantly different skills, training, education, etc. and be compensated correspondingly with different salaries. By generating salary information output based on the actual skills, this problem can be circumvented.

Moreover, in accordance with the illustrated embodiment, the salary data stored in the employment salary database 16 is actual salary data obtained from various sources such as job listings and/or employment histories from employees from resumes. Such sources of information specifically identify the functional skills required or possessed in contrast to conventional employment salary information systems that merely utilize survey data, which as previously described, requires selection of a predefined listing of job titles which may, or may not, actually represent the skill requirements of a job or a skill possessed by an employee.

In accordance with the illustrated embodiment of the present invention, the inputted employment parameter information which is inputted into the access device 40 preferably also includes a skill level. The skill levels are provided to indicate the level of experience and expertise with respect to particular skills, for example, the functional skill inputted as the employment parameter information. The skill levels may include junior, mid-career, senior, and guru levels corresponding to the spectrum of level of experience and expertise.

Providing such skill levels as an employment parameter information would be beneficial if it can be used to further narrow the salary data of the employment salary information database 16 to thereby provide even more accurate salary information output. However, salary data that is generally available from various sources such as the jobs database 32 and/or the resume database 34 are not provided with associated skill level information. In addition, such information is typically not provided in survey data that is utilized by conventional employment salary information systems. Furthermore, just as the actual functional skills associated with a particular job title varies between organizations, the level of experience and expertise would also vary for each of the skill level categories depending on how these skill level categories are defined.

In the above regard, the processor 12 of the employment salary information system 10 may be further adapted to establish a plurality of skill level categories to divide at least a portion of the salary data that is stored in the employment salary database 16. This may be obtained by dividing at least a portion of the salary data in the employment salary database 16 into predetermined percentile salary ranges, and correlating each of the predetermined percentile salary ranges to a plurality of skill level categories.

For example, the salary data that is stored in the employment salary database 16 may be divided into a junior skill level which correspond to salary data in which the amount of salary falls within the 0 to 30th percentile, a mid-career skill level which correspond to salary data in which the amount of salary falls within the 31 to 60th percentile, and a mid-career skill level which correspond to salary data in which the amount of salary falls within the 31 to 60th percentile, a senior skill level which correspond to salary data in which the amount of salary falls within the 61 to 85th percentile, and a guru skill level which correspond to salary data in which the amount of salary falls within the 86 to 100th percentile. Of course, these skill level categories are provided as merely one example, and the percentile range of the salaries which are correlated to each of the skill level categories are merely provided as exemplary implementation only. In this regard, in other embodiments of the present invention, additional skill level categories may be provided and different percentile ranges may be correlated to the skill level categories used.

With this additional skill level employment parameter information, the employment salary information system 10 generates salary information output based on both the skill matched dataset as described above, as well as the inputted skill level and the salary data of one of the predetermined percentile salary ranges. The described division of the salary data in the employment salary database 16 and generation of the salary information output using the salary data of one of the skill level categories in accordance with the described embodiment works under the premise that higher the skill level of the employee which corresponds to increased experience and expertise, higher the compensation for that employee. Again, the above described method for providing skill levels and corresponding skill categories is merely one example method and other methods may be utilized in other embodiments as well.

The salary data stored in the employment salary database 16 that is used by the employment salary information system 10 to generate the salary information output may be further narrowed based on various other inputted employment parameter information provided through the access device 40 to thereby further enhance the accuracy of the salary information generated. For example, the inputted employment parameter information may include a job title and the salary data may include associated job titles so that the processor 12 can generate a title matched dataset by searching the employment salary database 16 to identify salary data having the inputted job title associated thereto. Thus, the salary information output may be generated also based on the inputted job title and the salary data from the functional matched dataset.

Alternatively, or in addition thereto, the inputted employment parameter information may further include location information and the salary data may also include associated location data so that the processor 12 can generate a location matched dataset by searching the employment salary database 16 to identify salary data having the inputted location data associated thereto. The processor 12 may then generate the salary information further based on the inputted location information and the salary data of the location matched dataset. Thus, the further narrowing of the salary data based on additional inputted employment parameter information that is used by the salary information system 10 allows the enhancement of the accuracy of the generated salary information output that is provided to the user of the access device 40.

Moreover, the employment salary information system 10 in accordance with the illustrated embodiment may also be adapted to further enhance the accuracy of the salary information output generated by further narrowing the salary data used to generate the salary information. In this regard, the processor 12 may be further adapted to perform a relational match on the salary data which has been narrowed as previously described. This may be obtained by parsing the information associated with the salary data and comparing the associated information of the salary data to each other. The rest of the information associated with the salary data is examined, and salary data are substantially similar in content to each other based on the parsed information. Salary data having associated information that are similar in content to each other are used by the employment salary information system 10 to generate the salary information output. Salary data having associated information that are not similar in content is not used by the employment salary information system 10 to generate the salary information output.

In particular, because each job listings and/or resume may contain up to hundreds of terms, the relational match goes beyond the skill set information inputted by the user to examine other content of the records such as for particular certification or qualification and/or education. For example, if a user inputs the terms “oracle”, “sales”, “administration”, “stored procedures”, “database” as the employment parameter information, the employment salary information system 10 would initially identify the salary data stored in the employment salary database 16 having such terms associated thereto in the manner previously described. However, such terms may be equally applicable in describing positions of an oracle database administrator or an oracle sales person. Thus, by conducting the relational match, salary data having information associated thereto that is not similar in content is not used by the employment salary information system 10 so that the quality of the salary information output is enhanced. Of course, it should be evident that as the quality of the inputted employment parameter information increases, the importance of the relational match in enhancing accuracy of the salary information output is reduced.

In accordance with another aspect of the present invention, the employment salary information system 10 as shown in FIG. 1 may further include a data miner module 18 as previously noted. The data miner module 18 is adapted to generate and control a data miner 19 which functions to access the jobs database 32, the resume database 34, and/or other sources of salary data via the distributed network 30, and to provide the mined data from such sources to the employment salary database 16 of the employment salary information system 10 for storage.

In this regard, the data miner 19 that is generated by the data miner module 18 may be any appropriate type of information gatherer such as a crawler, a bot, a spider, etc. The data miner 19 may be adapted to periodically update the salary data stored in the employment salary database 16 so that the salary information output generated by the employment salary information system 10 that is provided to the access device 40 can also correspondingly be updated. The details of such data miners are known in the art, the details of which are omitted herein.

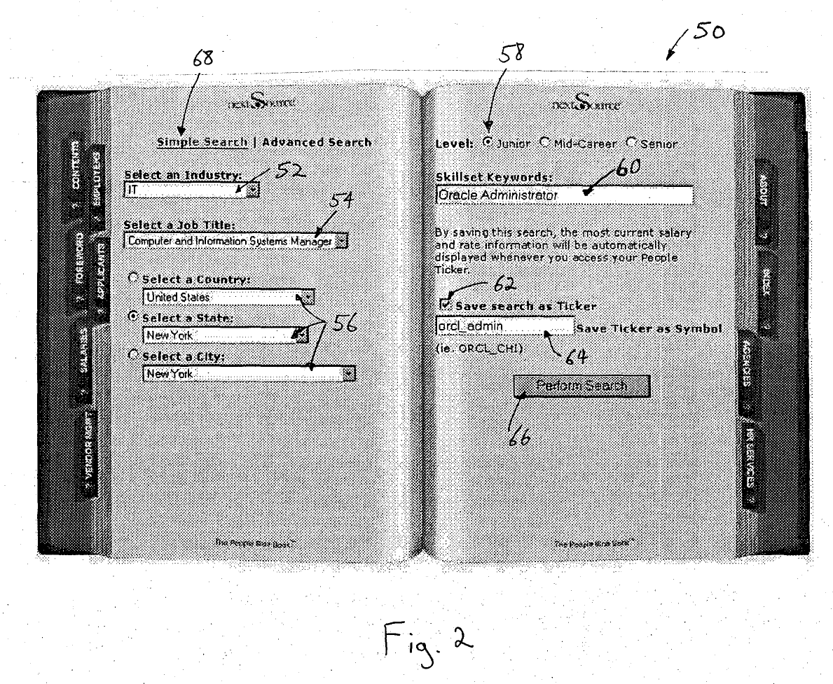

FIG. 2 shows one exemplary embodiment of the user interface 15 which is generated by the user interface module 14 of the employment salary information system 10 as shown in FIG. 1. As previously described, the user interface 15 is provided on the output device 44 of the access device 40 so that the user can input employment parameter information via the input device 42, and obtain salary information output from the employment salary information system 10. In this regard, the illustrated embodiment of the input screen 50 for the user interface 15 as shown in FIG. 2 is rendered as an “open book” graphic to provide the user the impression and feel of viewing open pages of a book. Of course, this rendering is merely one example and the user interface 15 may be rendered in any appropriate manner in other embodiments.

The input screen 50 is provided with a plurality of selectable items and/or dropdown menus to allow input of employment parameter information as described in further detail herein below. In particular, the illustrated embodiment of the input screen 50 is provided with an industry dropdown menu 52 that allows the user to generally limit the salary data from the employment salary database 16 which is used to generate the salary information output by industry. As shown, information technology (IT) may be one industry. Of course, various other industries may be provided in the industry dropdown menu 52 to provide initial narrowing of the salary data used in generating the salary information output. For example, other industries may include the legal industry, business consulting, etc.

The input screen 50 is also provided with a job title dropdown menu 54 which may be populated with various job titles that are commonly used in the selected industry, and/or be populated with job titles which are inputted by the user of the access device 40. The entry of the job titles in the job title dropdown menu 54 allows the user to input a job title which more accurately describe the particular functions of the job rather than being forced to select from a predetermined list of job titles which may, or may not, accurately represent the actual functions performed in the job as previously noted.

In addition, as also shown, the input screen 50 of the present example is also provided with a plurality of geographical location dropdown menus 56 which allows selection of a country, state, and/or city. The provision of the geographical location dropdown menus allows the salary data from the employment salary database 16 to be narrowed based on geography location in generating the salary information output since geographical location may play a significant role in the salaries of employees having the exact same skills.

Furthermore, the illustrated embodiment of the user interface 50 as shown in FIG. 2 is provided with a skill level selector 58 which allows the user to select the skill level for the salary information output to be generated. As can be seen, three skill levels are provided in the illustrated embodiment including: junior, mid-career, and senior. Of course, these skill levels are merely exemplary and in other embodiments of the present invention, different skill levels and numbers of skill levels may be provided. For instance, as previously discussed, a level of “guru” may also be provided. The selection of one of the skill levels 58 allows the employment salary information system 10 to further narrow the salary data of the employment salary database 16 which is used to generate the salary information output provided to the access device 40. As previously described, these levels may be obtained by dividing at least a portion of the salary data in the employment salary database 16 into predetermined percentile salary ranges, and correlating each of the predetermined percentile salary ranges to a plurality of skill level categories. When a specific level is indicated by the selection of one of the skill levels 58, salary data from only the corresponding level is utilized to generate the salary information output thereby enhancing its accuracy.

A skill set key words window 60 is also provided in the present embodiment of the input screen 50 to allow entry of functional skill information so that the employment salary information system 10 can generate the salary information output in the manner previously described above using inputted functional skill information. In particular, as previously described, the employment salary information system 10 may be adapted to generate a skill matched dataset by searching the employment salary database 16 to identify salary data having the specific skills that are inputted into the skill set key words window 60, and generate salary information based on the salary data of the skill matched dataset.

Furthermore, a ticker checkbox 62 may be provided to allow the user to indicate whether a ticker associated with the particular salary information output is to be generated by the ticker generation module 20 of the employment salary information system 10. In this regard, the generated salary information output may be rendered in the ticker by providing a symbol for the employment parameter information in the symbol window 64. By selecting the “perform search” button 66, the employment salary information system 10 in accordance with the present invention processes the salary data stored in the employment salary database 16 based on the various employment parameter information as inputted through the input screen 50 of the user interface 15 as shown in FIG. 2, to generate a salary information output described in further detail hereinbelow.

In addition, it should also be noted that the input screen 50 as shown in FIG. 2 may be considered to be an advance search input screen. In this regard, a more simple input screen may be generated by selecting the simple search link 68 which may be adapted to generate an input screen having fewer employment parameter information that must be inputted by the user. Of course, it should be again emphasized that the input screen 50 of the illustrated embodiment is merely one example, and the user interface 15 may be rendered on the output device 44 of the access device 40 in any appropriate manner.

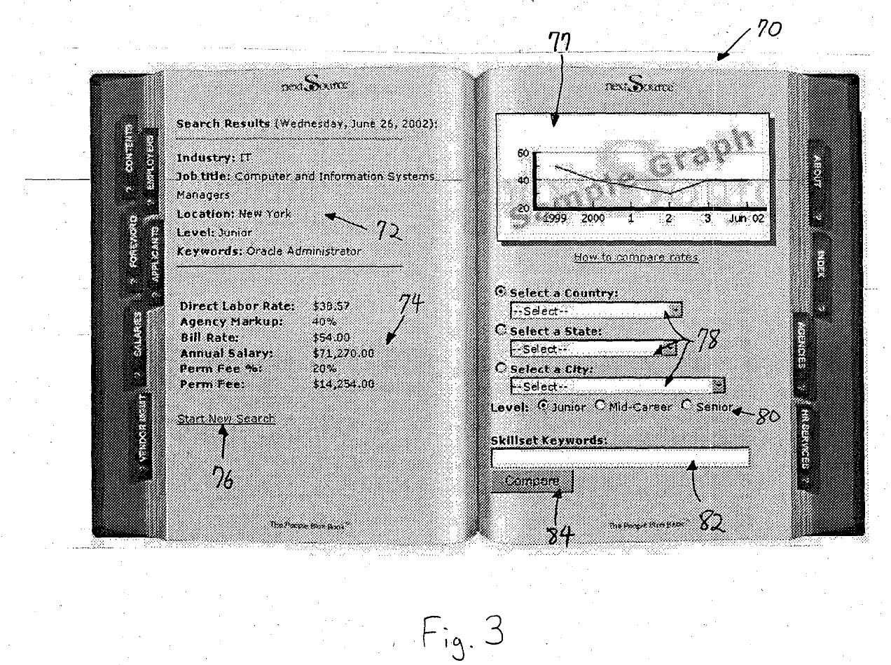

FIG. 3 shows an output screen 70 of the user interface 15 that is displayed by the user interface module 14 when the employment salary information system 10 has generated the requested salary information output in the manner described based on the employment parameter information inputted into the input screen 50 of FIG. 2, and the salary data stored in the employment salary database 16. As can be seen, the output screen 70 is also rendered as an open book in the illustrated embodiment. However, as previously noted, the output screen may be rendered in any appropriate manner in other embodiments.

As shown, the employment parameter information 72 that has been inputted is displayed on the output screen 70. In addition, the salary information output 74 which has been generated by the employment salary information system 10 is also provided on the output screen 70. As can be seen, in the illustrated example, the employment parameter information inputted in the input screen 50 of FIG. 2, was used to generate the direct labor rate, agency mark-up, bill rate, annual salary, permanent placement fee percentage, and permanent fee. As can be appreciated, the salary information output 74 are specifically generated in response to the various employment parameter information 72 and is generated based on the salary data stored in the employment salary database 16 in the manner previously described.

As can also be seen, the output screen 70 of the illustrated embodiment is further adapted to provide a trend graph 77 which visually illustrates the direct labor rate as a function of time so that the general trend of the direct labor rate can be determined. Of course, in other implementations of the output screen, the trend graph 77 may illustrate the trends of any of the salary information output 74, for instance, it may show the annual salary in other embodiments.

Of course, if the employment parameter information 72 is altered or changed in any manner, the salary information output 74 will also correspondingly change. In this regard, the output screen 70 as shown in FIG. 3 may further be provided with a new search link 76. Upon selection of the new search link 76, the input screen 50 of FIG. 2 would again, be displayed to allow the user to obtain salary information output based on different employment parameter information.

Moreover, in accordance with the illustrated embodiment, the output screen 70 may further be provided with a comparative feature in which the salary information output 74 that is generated based on the initial inputted employment parameter information, can be compared to salary information output generated from alternative employment parameter information. In this regard, the user may select an alternative geographical location using the geographical location dropdown menus 78, select a different skill level by selecting an alternative skill level 80, and/or enter different functional skills in the skill set key word windows 82.

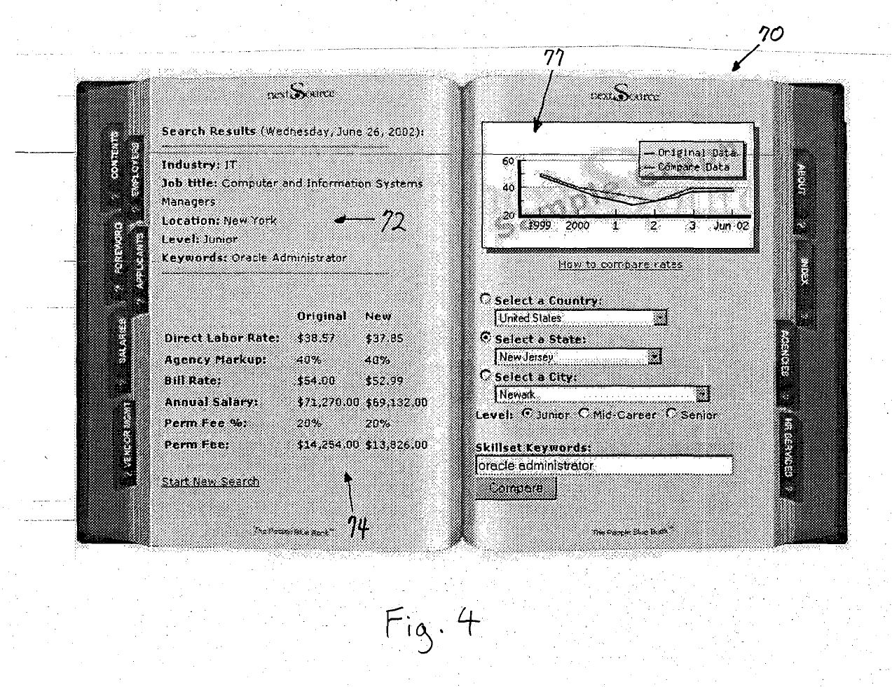

Upon selection of the “compare” button 84, the employment salary information system 10 generates new salary information output based on the comparative inputs and displays the output screen 70 as shown in FIG. 4. As shown, the output screen 70 now displays the salary information output 74 which compares the output based on the original employment parameter information 72, and the comparative employment parameter information entered. Moreover, the trend graph 77 displays the equivalent data for the comparative salary information output.

The newly generated salary information output may again be altered by changing the employment parameter information using the geographical location dropdown menus 78, the skill level selection 80, and/or the skill set key word window 82, and clicking on the compare button 84 in the manner previously described. This causes employment salary information system 10 to generate salary information output based on the newly selected employment parameter information, and update the output screen 70 so that the salary information output 74 under the “new” column is accordingly based on the new salary parameter information. As can be readily appreciated, this allows quick comparison of salary information based on various employment parameter information.

As previously noted, the employment salary information system 10 includes a ticker generation module 20 which is adapted to render the salary information output as a ticker 21 on the output device 44 of the access device 40. Referring to the input screen 50 of FIG. 2, when the user checks the box to save the search as a ticker in the ticker checkbox 62, and further enters a symbol in the symbol window 64, the ticker generation module 20 renders the salary information output in a ticker screen under the saved ticker symbol, for example, “orcl admin” as shown in FIG. 2.

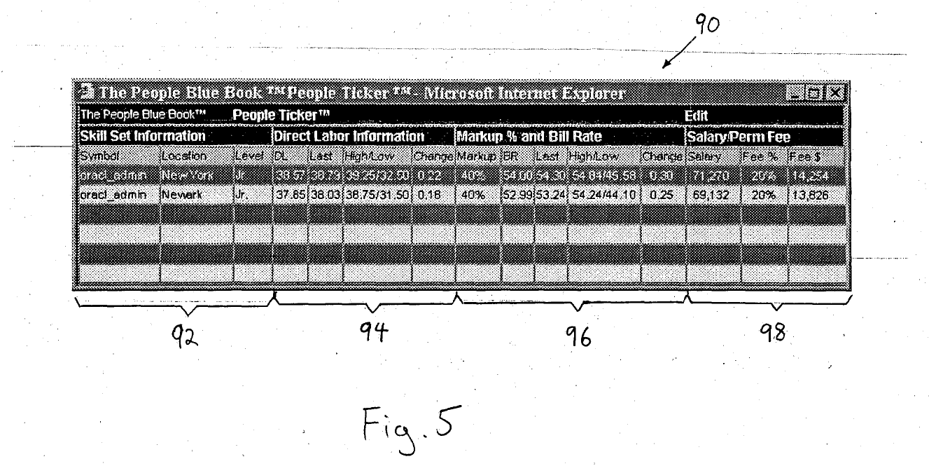

FIG. 5 illustrates an example ticker 90 corresponding to the schematically illustrated ticker 21 of FIG. 1. The illustrated example embodiment of the ticker 90 renders the salary information output that is generated by the employment salary information system 10 as a pop-up window on the output device 44. The ticker 90 sets forth skill set information 92, direct labor information 94, mark-up percent and bill rate 96, and salary/permanent placement fee 98 as described below.

In particular, under the skill set information 92, ticker 90 sets forth the ticker symbol, the location information, and the skill level. In addition, under the direct labor information 94, the current direct labor costs, the previous (last) direct labor costs, the high/low direct labor costs, and the amount of change is set forth. Under the mark-up percent and bill rate 96, the agency/vendor's mark-up, the current bill rate, the previous (last) bill rate, and high/low bill rates, as well as the change in the bill rate. Lastly, the ticker 90 as shown in FIG. 5 further provides the average salary, percentage of placement fee, and permanent placement fee under salary/perm fee 98.

The ticker 90 in accordance with the preferred embodiment of the present invention is periodically updated by the employment salary information system 10 so that the most current salary information output is provided to the user. In this regard, as previously noted, the employment salary information system 10 in accordance with the illustrated embodiment of FIG. 1, is provided with a data miner module 18 which is adapted to generate a data miner 19 that mines for salary data via the distributed network 30. As previously described, a data miner 19 may be adapted to obtain salary data from any variety of sources including jobs database 32 having salary information of actual jobs and/or the resume database 34 having salary data derived from employment histories.

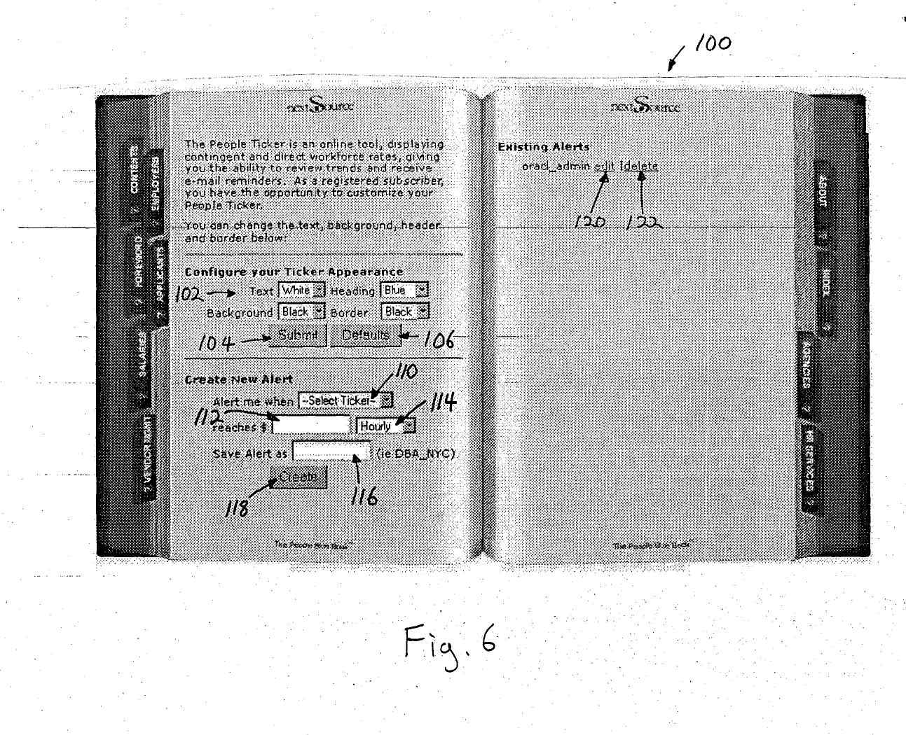

The user interface module 14 of the employment salary information system 10 may further be adapted to allow customization of the ticker's appearance. In this regard, the user interface module 14 may be adapted to generate options screen 100 as shown in FIG. 6 which is provided with a plurality of customization dropdown menus 102 that allow the user of the access device 40 to select the colors of the ticker. In this regard, a “submit” button 104 may be provided to apply the colors indicated, and a “default” button 106 may be provided to reset the dropdown menus 102 to default values.

In addition, in the illustrated embodiment of the options screen 100, the employment salary information system 10 is further adapted to allow generation of alerts based on certain parameters associated with a ticker. In particular, as shown in the options screen 100 of FIG. 6, the user of the access device 40 may request an alert to be generated and sent, for example, via e-mail, when a particular ticker reaches a certain monetary amount. In this regard, a ticker selection dropdown menu 110 as well as amount window 112 and units dropdown menu 114 may be provided so that the user of the access device 40 can input the desired conditions at which the employment salary information system 10 generates an alert indicating the satisfaction of the various conditions. The alert may be named using the naming window 116. This feature is put into force by selecting the “create” button 118 which causes the creation of the indicated alert. Moreover, the created alerts are displayed and may be deleted and/or edited by selecting the edit link 120 or delete link 122 that is positioned in proximity to the existing alert as shown.

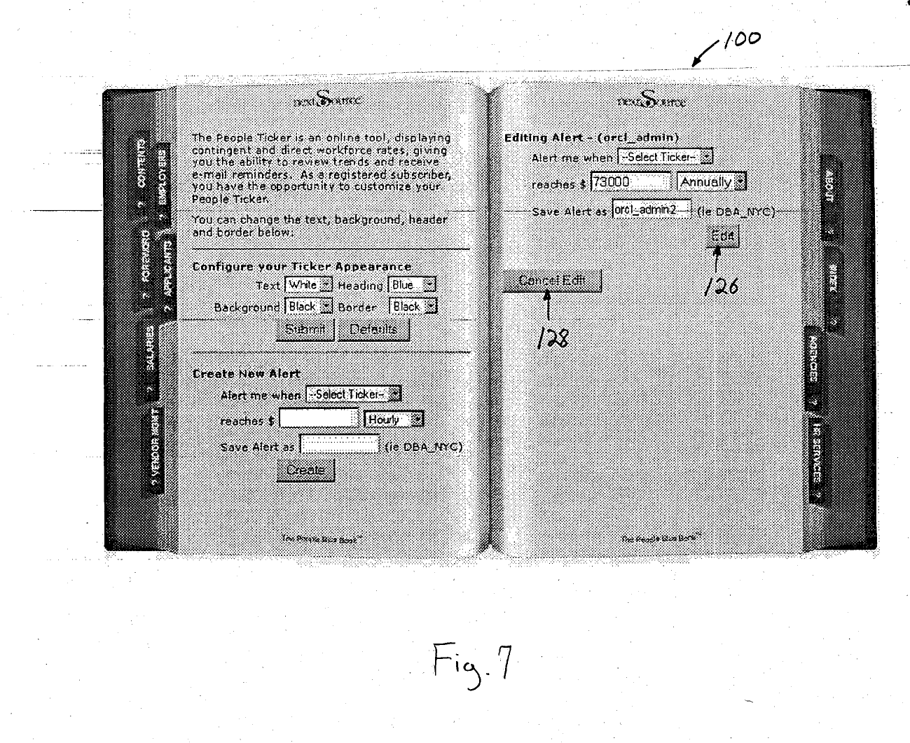

FIG. 7 shows the options screen 100 in which the edit link 120 for editing the alert named “oracl admin” has been selected. As shown, the various conditions that are associated with the ticker name may now be modified and saved by clicking the “edit” button 126. Furthermore, “cancel edit” button 128 is provided in the options screen 100 to allow the user to revert back to the original set conditions of the alert. Of course, it should be readily apparent to one of ordinary skill in the art that the above discussed implementation of the ticker as well as the option screens are provided merely as an example implementation. Consequently, the ticker, as well as any user interface screens associated therewith, may be implemented in a different manner in other embodiments of the present invention.

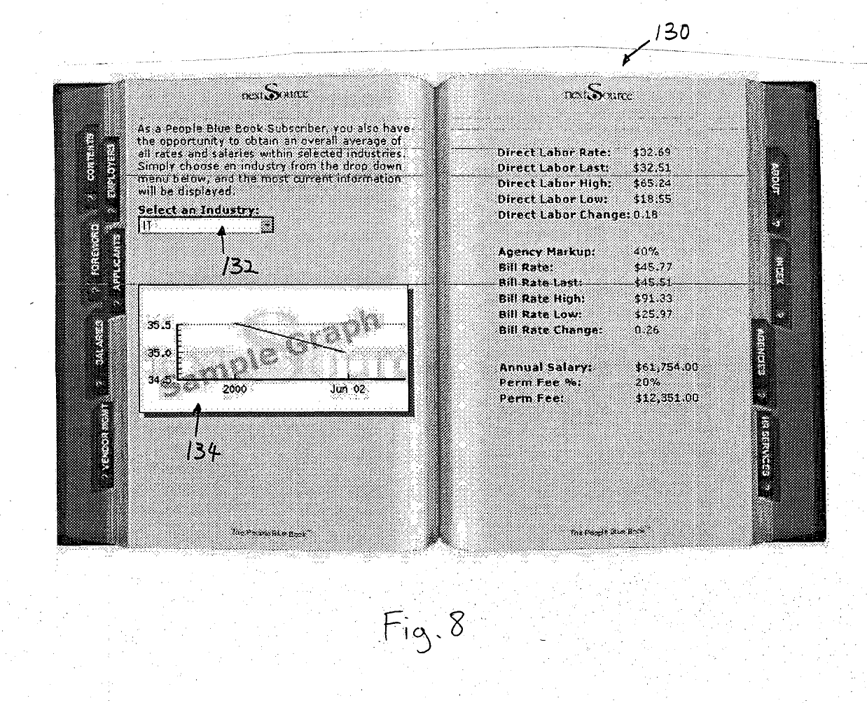

FIG. 8 shows an industry summary screen 130 that may be generated by the employment salary information system 10. The industry summary screen 130 allows the user of the access device 40 to obtain industry wide salary information, without regard to any specific employment parameter information. In this regard, the industry summary screen 130 is provided with an industry selector dropdown menu 132 which allows the user to select the industry of interest. Upon such selection, the employment salary information system 10 displays various direct labor statistics, agency and bill rate information, as well as the salary and permanent placement fee information as shown. Furthermore, a trend graph 134 may be generated to show the general trend of the selected industry.

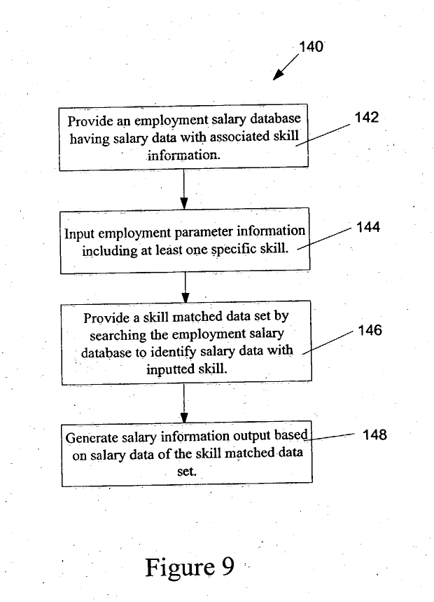

It should now be evident that another aspect of the present invention is in providing a method providing employment salary information. In this regard, FIG. 9 shows a flow diagram 140 illustrating a method for providing employment salary information in accordance with one embodiment of the present invention. As can be seen, the method includes the step of providing an employment salary database in step 142, the database having salary data with associated skill information. Employment parameter information is inputted in step 144, the inputted employment parameter information including at least one specific skill. In step 146, a skill matched dataset is provided by searching the employment salary database to identify salary data with the skill inputted in step 144. Finally, salary information output is generated in step 148 based on the skill matched dataset.

Of course, the flow diagram 140 of FIG. 9 merely illustrates one example method which should be evident in view of the discussion above. Additional steps may be provided in the manner discussed above such as the step of establishing plurality of skill level categories and generating salary information output based on the skill level categories and inputted skill level. Furthermore, additional employment parameter information may be inputted including job title, location information, etc., and the salary information output may be generated based thereon. Moreover, additional steps of mining salary data and updating salary information output may be included in other embodiments of the present method as well.

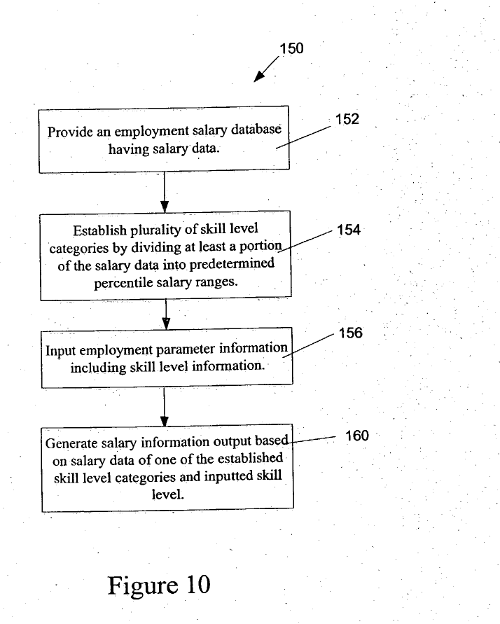

FIG. 10 also shows a flow diagram 150 in accordance with another aspect of the present invention for providing employment salary information. As can be seen, the method of the present embodiment includes the step of providing an employment salary database having salary data in step 152. In step 154, a plurality of skill level categories are established by dividing at least a portion of the salary data into predetermined percentile salary ranges. Employment parameter information is inputted in step 156, the inputted employment parameter information including skill level information. Salary information output is generated based on the salary data of one of the established skill level categories, as well as the inputted skill level in step 158. Again, the above described method as shown in FIG. 10 is merely one example of the methods in accordance with the present invention. In addition, in other embodiments, additional steps may be provided as well.

Thus, in view of the above, it should be apparent to one of ordinary skill in the art that the present invention provides a system and method for providing updated employment salary information which takes into consideration, various employment parameters including the geographical location of employment, and experience the level of expertise, as well as the actual functional skill set of the employee.

Furthermore, it should also be apparent that the present invention may be implemented as software that is stored on a data storage media with computer executable instructions for providing employment salary information. The data storage media may comprise instructions for providing an employment salary database for storage of salary data with associated skill information, instructions for allowing input of employment parameter information, wherein the employment parameter information includes at least one specific skill, instructions for providing a skill matched data set by searching the employment salary database to identify salary data with the inputted skill associated thereto, and instructions for generating salary information based on salary data of the skill matched data set. In this regard the data storage media may also further include instructions for establishing plurality of skill level categories and instructions for generating salary information based on salary data of one of the established skill level categories. Of course, the data storage media may be provided with additional instructions for affecting the functions of the system and methods described above.

While various embodiments in accordance with the present invention have been shown and described, it is understood that the invention is not limited thereto. The present invention may be changed, modified and further applied by those skilled in the art. For example, various components of the system and steps of the method may be omitted and/or added to. Therefore, this invention is not limited to the detail shown and described previously, but also includes all such changes and modifications.

We claim:

1. A system for providing employment salary information comprising:
an employment salary database having salary data with associated skill information;
a user interface module adapted to allow input of employment parameter information including at least one specific skill; and
a processor adapted to generate a functional skill matched data set by searching said employment salary database to identify salary data having said inputted specific skill associated thereto, and generate salary information based on salary data of said skill matched data set.

2. The system of claim 1, wherein said inputted employment parameter information also includes skill level, and said processor is further adapted to establishing plurality of skill level categories.

3. The system of claim 2, wherein said processor establishes said plurality of skill level categories by dividing at least a portion of said salary data in said employment salary database into predetermined percentile salary ranges, and correlating each of said predetermined percentile salary ranges to said plurality of skill level categories.

4. The system of claim 3, wherein said processor is further adapted to generate said salary information based also on said inputted skill level, and salary data of one of said predetermined percentile salary ranges.

5. The system of claim 1, wherein said salary data includes associated job titles, and said inputted employment parameter information further includes a job title.

6. The system of claim 5, wherein said processor is further adapted to narrow said salary data by searching said employment salary database to identify salary data having said inputted job title associated thereto.

7. The system of claim 5, wherein said processor is further adapted to generate said salary information based also on said inputted job title.

8. The system of claim 1, wherein said salary data includes associated location data, and said inputted employment parameter information further includes location information.

9. The system of claim 8, wherein said processor is further adapted to narrow said salary data by searching said employment salary database to identify salary data having said inputted location data associated thereto.

10. The system of claim 8, wherein said processor is adapted to generate salary information based on said inputted location information.

11. The system of claim 1, further comprising a data miner adapted to periodically mine employment salary data.

12. The system of claim 11, wherein said processor is further adapted to store said mined employment salary data in said employment salary database.

13. The system of claim 11, wherein said data miner is adapted to periodically mine employment data through a distributed network.

14. The system of claim 11, wherein said data miner is adapted to mine salary data from job listings.

15. The system of claim 11, wherein said data miner is adapted to mine salary data from employment histories.

16. The system of claim 1, wherein said generated employment salary information includes average annual salary.

17. The system of claim 16, wherein said average annual salary is periodically updated.

18. The system of claim 17, further comprising a ticker adapted to render said generated employment salary information.

19. The system of claim 18, wherein said ticker renders at least one of direct labor hourly rate, highs and lows of said direct labor hourly rate, and amount of change in said direct labor hourly rate.

20. The system of claim 18, wherein said ticker renders at least one of an hourly pay rate that includes fees charged by an employment agency, and amount of fees charged by an employment agency as a percentage of an hourly pay rate.

21. A method for providing employment salary information comprising the steps of:
providing an employment salary database having salary data with associated skill information;
inputting employment parameter information, wherein said employment parameter information includes at least one specific skill;
providing a skill matched data set by searching said employment salary database to identify salary data with said inputted skill associated thereto; and
generating salary information based on salary data of said skill matched data set.

22. The method of claim 21, further including the step of establishing plurality of skill level categories.

23. The method of claim 22, wherein said step of establishing plurality of skill level categories includes the step of dividing at least a portion of said salary data in said employment salary database into predetermined percentile salary ranges.

24. The method of claim 23, further including the step of correlating each of said predetermined percentile salary ranges to said plurality of skill level categories.

25. The method of claim 23, wherein said salary information generated is further based on salary data of one of said predetermined percentile salary ranges.

26. The method of claim 22, wherein said inputted employment parameter information includes a skill level.

27. The method of claim 26, wherein said salary information generated is further based on said inputted skill level.

28. The method of claim 21, wherein said salary data includes associated job titles, and said inputted employment parameter information further includes a job title.

29. The method of claim 28, wherein said salary information generated is further based on said inputted job title.

30. The method of claim 28, further including the step of narrowing said salary data by searching said employment salary database to identify salary data having said inputted job title associated thereto.,

31. The method of claim 30, wherein said salary information generated is further based on salary data of said job title.

32. The method of claim 22, wherein said salary data includes associated location data, and said inputted employment parameter information further includes location information.

33. The method of claim 32, wherein said salary information generated is further based on said inputted location information.

34. The method of claim, 32, further including the step of narrowing said salary data by searching said employment salary database to identify salary data having said inputted location data associated thereto.

35. The method of claim 34, wherein said salary information generated is further based on said inputted location information.

36. The method of claim 21, further including the step of periodically mining employment salary data.

37. The method of claim 36, further including the step of storing said mined employment salary data in said employment salary database.

38. The method of claim 36, wherein said employment salary data is mined through a distributed network.

39. The method of claim 21, wherein said employment salary database is generated using salary data mined from job listings.

40. The method of claim 21, wherein said employment salary database is generated using salary data mined from employment histories of employees.

41. The method of claim 21, wherein said generated employment salary information includes an average annual salary.

42. The method of claim 21, further including the step of periodically updating said generated employment salary information.

43. The method of claim 42, wherein said generated employment salary information is rendered as a ticker.

44. The method of claim 43, wherein said ticker includes at least one of direct labor hourly rate, highs and lows of said direct labor hourly rate, and amount of change in said direct labor hourly rate.

45. The method of claim 43, wherein said ticker includes at least one of an hourly pay rate that includes fees charged by an employment agency, and amount of fees charged by an employment agency as a percentage of an hourly pay rate.

46. A system for providing employment salary information comprising:
an employment salary database having salary data;
a user interface module adapted to allow input of employment parameter information including at least one specific skill; and
a processor adapted to establish a plurality of skill level categories by dividing at least a portion of said salary data in said employment salary database into predetermined percentile salary ranges, and generate salary information based on said inputted skill level and salary data of one of said predetermined percentile salary ranges.

47. The system of claim 46, wherein said processor is further adapted to correlate each of said predetermined percentile salary ranges to said plurality of skill level categories.

48. A method for providing employment salary information comprising the steps of:
providing an employment salary database having salary data;
establishing plurality of skill level categories by dividing at least a portion of said salary data in said employment salary database;
inputting employment parameter information, wherein said employment parameter information includes skill level information; and
generating salary information based on salary data of one of said established skill level categories.

49. The method of claim 48, wherein said step of establishing plurality of skill level categories by dividing at least a portion of said salary data includes dividing said portion of said salary data into predetermined percentile salary ranges.

50. The method of claim 49, wherein said salary information generated is further based on said inputted skill level.

51. A data storage media with computer executable instructions for providing employment salary information comprising:
instructions for providing an employment salary database for storage of salary data with associated skill information;
instructions for allowing input of employment parameter information, wherein said employment parameter information includes at least one specific skill;
instructions for providing a skill matched data set by searching said employment salary database to identify salary data with said inputted skill associated thereto; and
instructions for generating salary information based on salary data of said skill matched data set.

52. The data storage media of claim 51, further including instructions for establishing plurality of skill level categories.

53. The data storage media of claim 52, wherein said instructions for establishing plurality of skill level categories includes instructions for dividing at least a portion of said salary data in said employment salary database into predetermined percentile salary ranges.

54. The data storage media of claim 53, further including instructions for correlating each of said predetermined percentile salary ranges to, said plurality of skill level categories.

55. The data storage media of claim 53, wherein said salary information generated is further based on salary data of one of said predetermined percentile salary ranges.

56. The data storage media of claim 52, wherein said inputted employment parameter information includes a skill level.

57. The data storage media of claim 56, wherein said salary information generated is further based on said inputted skill level.

58. The data storage media of claim 51, wherein said salary data includes associated job titles, and said inputted employment parameter information further includes a job title.

59. The data storage media of claim 58, wherein said salary information generated is further based on said inputted job title.

60. The data storage media of claim 58, further including instructions for narrowing said salary data by searching said employment salary database,to identify salary data having said inputted job title associated thereto.

61. The data storage media of claim 60, wherein said salary information generated is further based on salary data of said job title.

62. The data storage media of claim 52, wherein said salary data includes associated location data, and said inputted employment parameter information further includes location information.

63. The data storage media of claim 62, wherein said salary information generated is further based on said inputted location information.

64. The data storage media of claim 62, further including instructions for narrowing said salary data by searching said employment salary database to identify salary data having said inputted location data associated thereto.

65. The data storage media of claim 64, wherein said salary information generated is further based on said inputted location information.

66. The data storage media of claim 51, further including instructions for periodically mining employment salary data.

67. The data storage media of claim 66, further including instructions for storing said mined employment salary data in said employment salary database.

68. The data storage media of claim 66, wherein said employment salary data is mined through a distributed network.

69. The data storage media of claim 51, wherein said employment salary database is generated using salary data mined from job listings.

70. The data storage media of claim 51, wherein said employment salary database is generated using salary data mined from employment histories of employees.

71. The data storage media of claim 51, wherein said generated employment salary information includes an average annual salary.

72. The data storage media of claim 51, further including instructions for periodically updating said generated employment salary information.

73. The data storage media of claim 72, wherein said generated employment salary information is rendered as a ticker.

74. The data storage media of claim 73, wherein said ticker includes at least one of direct labor hourly rate, highs and lows of said direct labor hourly rate, and amount of change in said direct labor hourly rate.

75. The data storage media of claim 73, wherein said ticker includes at least one of an hourly pay rate that includes fees charged by an employment agency, and amount of fees charged by an employment agency as a percentage of an hourly pay rate.

76. A data storage media for providing employment salary information comprising:
instructions for providing an employment salary database having salary data;
instructions for establishing plurality of skill level categories by dividing at least a portion of said salary data in said employment salary database;
instructions to allow input of employment parameter information, wherein said employment parameter information includes skill level information; and
instructions for generating salary information based on salary data of one of said established skill level categories.

77. The data storage media of claim 76, wherein said instructions for establishing plurality of skill level categories by dividing at least a portion of said salary data includes instructions for dividing said portion of said salary data into predetermined percentile salary ranges.

78. The data storage media of claim 77, wherein said salary information generated is further based on said inputted skill level.
